(19) United States
(12) Patent Application Publication
(10) Pub. No.: US 2012/0145698 A1
(43) Pub. Date: Jun. 14, 2012

(54) KETTLE

(76) Inventor: Michael Von Seidel, Somerset West (ZA)

(21) Appl. No.: 13/392,470

(22) PCT Filed: Aug. 31, 2009
(86) PCT No.: PCT/IB09/06697

§ 371 Date: Feb. 24, 2012

(51) Int. Cl. A47J 27/21

(52) U.S. Cl. 219/438

(57) ABSTRACT

A kettle (1) is provided having a body (2) with a lowermost outer periphery (3), a water chamber (4) inside the body wherein the water chamber has a bottom (5), a lower region (6) immediately above the bottom and a central region (7) that together define a maximum volume of water of at least 1 litre, and typically from 1.4 to 1.8 litres. A transparent wall section or window (9) enables visual observation of the water level. Electrical heating means (11, 21, 27, 28) are provided for heating the water. The lower region of the water chamber has an average horizontal sectional area that is not more than 75%, and preferably not more than 50% of the area enclosed by the lowermost outer periphery. This enables one or 2 cups of water to occupy a greater vertical height in the water chamber and a minimum volume of water of 400 millilitres, and preferably 300 millilitres or less to be visible through the transparent wall section or window. The arrangement greatly facilitates introducing only one or two cups of water into the kettle.

### FIELD OF THE INVENTION

This invention relates to an electric kettle or, as it is sometimes referred to, electrically heated jug, whereby small quantities of water of up to about one to two litres can be heated, typically to boiling point, for the purpose of making beverages or utilising the boiling water for any other purpose that may be food preparation or cooking.

It is to be understood that the term “kettle” as used in this specification is intended to include any domestic type of water heating apparatus having a single volume water chamber with electrical heating means at or towards the bottom thereof whereby a variable volume of water can be brought to the boil, or close to the boil, with the variable volume having a maximum of from about 1 litre to about 2 litres and a minimum that is dependent on the configuration of the water chamber and electrical heating means.

### BACKGROUND TO THE INVENTION

Kettles are frequently used for the purpose of heating water in order to make a single cup of beverage or, on many other occasions, 2 cups of beverage. Standard kettles having a maximum capacity of from about 1.2 to about 1.8 litres of water frequently have a minimum recommended water content of about 500 millilitres.

What this means is that if only one cup of boiling water is required, and accepting that a cup in metric terms typically translates into 250 millilitres, double the amount actually required is boiled even if the kettle is only filled to its minimum recommended operating level.

Added to this is the difficulty of filling an average kettle to exactly the minimum level and the tendency is always rather to add more water in order to avoid having less than the minimum.

With the increasing global concern about unnecessary consumption of electrical energy, a number of proposals have been put in place that seek to enable a single cap of hot water to be produced. Some of these are more complex appliances in which only a required small quantity of water is heated in a separate chamber or partition. These proposals are therefore more cumbersome than a simple single water chamber kettle; and more costly. Their efficiency may also be wanting, at least to some extent.

The more simple proposals have apparently concentrated on decreasing the minimum amount of water that can be boiled in the kettle. In spite of the fact that there may have been limited success in achieving the objective, there remains the difficulty of reasonably accurately filling a kettle, for example with only 250 millilitres, or even 500 millilitres of water, or whatever other similar small volume is required.

The bottom of the water chamber is typically of the largest horizontal cross-sectional size of the water chamber and therefore the height or level of water that corresponds to such a small volume of water is itself small and accompanied by the difficulty mentioned above of filling the kettle to exactly the required level.

In the instance of a circular kettle having a base of about 16 cm in diameter, the water level corresponding to a content of 300 ml is only about 15 millimetres. The difficulty is exacerbated by the fact that a kettle is generally hand held in midair whilst water is introduced into it, typically from a tap, and the large bottom would invariably be tilted in one direction or another thereby giving a false reading of the content through the usual transparent window or sidewall of the body that defines the water chamber. Once more, the tendency is rather to add more water in order to avoid having less than the required minimum quantity and thereby risking damage to the kettle.

The overall result is that when only one cup of boiling water is required, usually between two and 3 cups, or even more, are boiled which represents in excess of 100% wastage of electrical energy.

### OBJECT OF THE INVENTION

It is an object of this invention to provide a kettle that has a suitably low minimum volumetric operating volume coupled with a satisfactorily large maximum volume and that is aimed at combating, at least to some extent, the difficulty of introducing small quantities of water into it, such as for the purpose of heating a quantity of water suitable for making one or two cups of beverage.

### SUMMARY OF THE INVENTION

In accordance with this invention there is provided a kettle having a body with a lowermost outer periphery, a water chamber inside the body wherein the water chamber has a bottom, a lower region immediately above the bottom, a central region terminating in an upper maximum recommended operating volume, and an upper region constituting a head space, the water chamber having a maximum operating volume suitable for receiving at least 1 litre of water, a transparent wall section or window through which a volume of water within the water chamber can be visually observed between at least a minimum and a maximum recommended operating volume, and electrical heating means associated with said lower region of the water chamber for operatively heating water present in the water chamber, the kettle being characterised in that the lower region of the water chamber has a capacity of not less than 200 millilitres, it has an average horizontal sectional area that is not more than 75% of the area enclosed by the lowermost outer periphery of the body, and a minimum volume of water of 400 millilitres or less is operatively visible through the transparent wall section or window.

Further features of the invention provide for the minimum volume visible through the transparent wall section or window to be about 300 millilitres and optionally as little as 250 millilitres or less; for the maximum operating volume of the water chamber to be at least 1.2 litres and preferably from 1.4 to 2.0 litres; for the horizontal sectional area of the lower region of the water chamber to have an average cross-sectional area that is less than 65% of the area enclosed by the lowermost outer periphery of the body, and preferably not more than 50%; for the horizontal sectional area of the lower region of the water chamber to increase from the bottom to the full horizontal sectional area of the body where the lower region meets the central region of the water chamber; for the wall of the body and the wall of the water chamber to be integral for at least the central region and upper region of the water chamber; and for the capacity of the lower region of the water chamber to be from 250 millilitres to 500 millilitres.

In one instance, the lower region of the water chamber may be formed as a diametrical channel extending between opposite sides of the lowermost outer periphery. In this instance, it is envisaged that either an immersion heating element or an external “underfloor” type of heating element may be appropriate.

In another instance, the lower region of the water chamber may be formed as a central reduced diameter region of smaller cross-sectional size than the lowermost outer periphery of the body. It is considered that with current heating element technology an appropriate heating element arrangement for such a lower region may be an immersion heating element having a hot section at or towards the bottom of the lower region of the water chamber.

In a third instance, the lower region of the water chamber may be of annular shape with a central raised part of the bottom of the water chamber forming an inner wall to the lower region of the water chamber. This arrangement is considered to be suitable to both internal and external “underfloor” heating element arrangements.

It will be understood that by providing a reduced cross-sectional area to the lower region of the water chamber, the vertical height of the water level in the lower region is greater than in the absence of such reduced cross-sectional area. For example, in the instance mentioned above of kettle having a 160 millimetres diameter base, the roughly 15 millimetres height that would correspond to a content of 300 millilitres of water in the absence of the implementation of this invention becomes 30 millimetres with a reduced cross-sectional area of one half of that of the base as is provided by this invention.

The increased height is much easier to use in practice and provides for greater accuracy in filling the lower region of the water chamber of the kettle. It also provides increased depth of the minimum amount of water for covering the heating element whether it be an internal immersion heating element or an external “underfloor” heating element below the bottom of the water chamber.

In order that the invention may be more fully understood different embodiments thereof will now be described with reference to the accompanying drawings.

### BRIEF DESCRIPTION OF THE DRAWINGS

In the drawings:—

FIG. 1 is a schematic isometric illustration of one embodiment of the invention;

FIG. 2 is a schematic side elevation of one variation thereof illustrating one form of graduated scale and capacity of the lower region;

FIG. 3 is a schematic sectional plan view thereof;

FIG. 4 is a schematic side elevation of another variation of the embodiment illustrated in FIG. 1 and illustrating a different graduated scale and capacity of the lower region;

FIG. 5 is a schematic isometric view similar to FIG. 1 but illustrating a second embodiment of the invention;

FIG. 6 is a schematic sectional plan view thereof;

FIG. 7 is a schematic isometric view similar to FIG. 1 but illustrating a third embodiment of the invention;

FIG. 8 is a schematic sectional plan view thereof as applied to a variation having an external “underfloor” heating element; and,

FIG. 9 is a schematic sectional Plan view thereof as applied to a variation having an internal immersion heating element.

### DETAILED DESCRIPTION WITH REFERENCE TO THE DRAWINGS

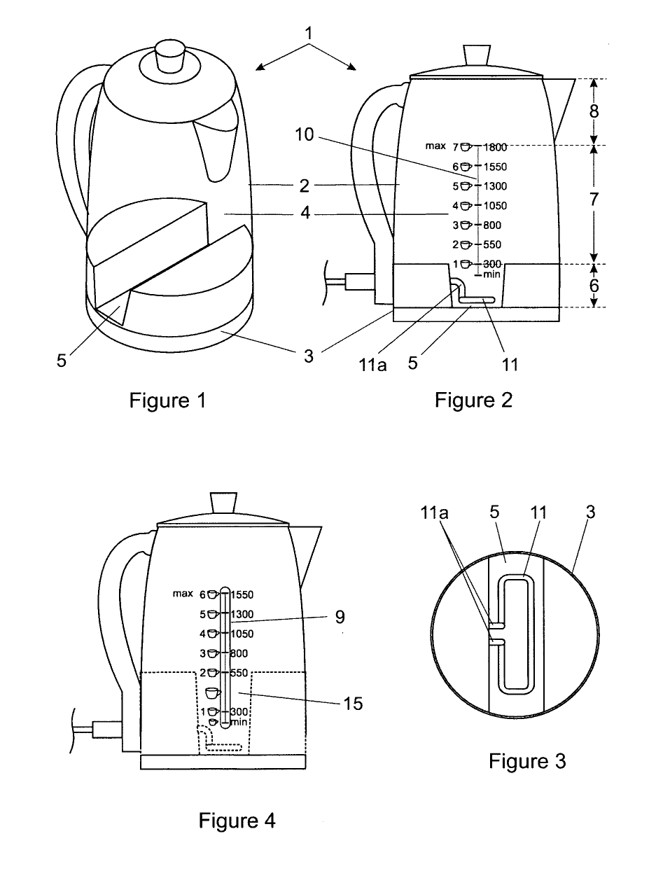

In the embodiment of the invention in FIGS. 1 to 3 a kettle (1) has a body (2) with a lowermost outer periphery (3), and a water chamber (4) inside the body. The water chamber has a bottom (5), a lower region immediately above the bottom indicated by numeral (6), a central region indicated by numeral (7) terminating in an upper maximum recommended operating volume, and an upper region indicated by numeral (8) constituting a head space.

The water chamber, in this embodiment of the invention, has a maximum operating volume of from 1.5 to 1.8 litres of water; that is the combined volumes of the lower (6) and central (7) regions of the body.

In practice, the body wall could be made of transparent material such as glass, as is the instance of the embodiment illustrated in FIG. 2, or it could have a window (9) as in the instance illustrated in FIG. 4 through an otherwise opaque body wall. As a further alternative an open topped, generally upright transparent tube communicating at least at the bottom with the interior of the water chamber could be used.

In any event, the volume of water within the water chamber can be visually observed against a graduated scale (10) between at least a minimum (in this instance 250 millilitres) and a maximum recommended operating volume (1.8 litres in the instance illustrated in FIG. 2).

The graduated scale includes an indication of how many cups of water are contained within the water chamber starting with 300 millilitres for one cup and 1.8 litres for seven cups on the basis that each cup is equivalent to 250 millilitres and a buffer of 50 millilitres is allowed. Of course, if design considerations allow, the buffer of 50 millilitres could be omitted. It is considered that this type of more detailed marking will assist in psychologically influencing users to pay more attention to the activity of charging the water chamber with an appropriate amount of water commensurate with that to be used.

The kettle is provided with suitable electrical heating means, in this instance in the form of an immersion heating element (11), towards the bottom of the lower region of the water chamber for operatively heating water present in the water chamber. The heating element has a hot section at or towards the bottom of the lower region of the water chamber with cold sections (11a) supporting same.

As provided by this invention, the lower region (6) of the water chamber has an average horizontal sectional area that is approximately 50% of the area enclosed by the lowermost outer periphery of the body. In the instance of a diameter of 160 millimetres of the outer periphery of the base, as indicated above, this will result in 300 millilitres having a surface at a vertical position of about 30 mm above the bottom of the lower region.

The lower region of the water chamber, in this instance, is formed as a diametrical channel extending between opposite sides of the outer periphery of the body corresponding to the lower region of the water chamber. The channel may have a width that increases somewhat from the bottom to the full horizontal sectional area of the body where the lower region meets the central region of the water chamber. The wall of the body and the wall of the water chamber are one for at least the central region and upper region of the water chamber whilst the channel shaped lower region of the water chamber could be formed in a number of different ways.

In one arrangement, the wall defining the lower region could be integral with the wall defining the central and upper regions in which instance the base would be made as a separate component to which the composite water chamber is attached.

In the alternative, the base could be integral with the wall of the water chamber over the central and upper regions and a shaped bottom could be inserted into the base of the body to form the lower region of the water chamber. It is also possible to simply install separately made volume occupying inserts of segment shape in cross-section (that is an area enclosed by an arc of a circle and a chord) at diametrically opposite positions in an otherwise conventional type of water chamber.

In either event, the immersion heating element may be shaped to a suitable elongate generally rectangular shape compatible with the plan view shape of the lower region of the water chamber.

Turning now to the variation that is illustrated in FIG. 4, the channel shaped lower region (15) of the water chamber is made substantially deeper and is dimensioned to accommodate 2 cups of water together with the buffer of 50 millilitres. This does, of course, diminish the overall capacity of the water chamber further and with the example given above of a base of 160 millimetres given about, this would mean that the 550 millilitre level would be located about 55 millimetres above the bottom.

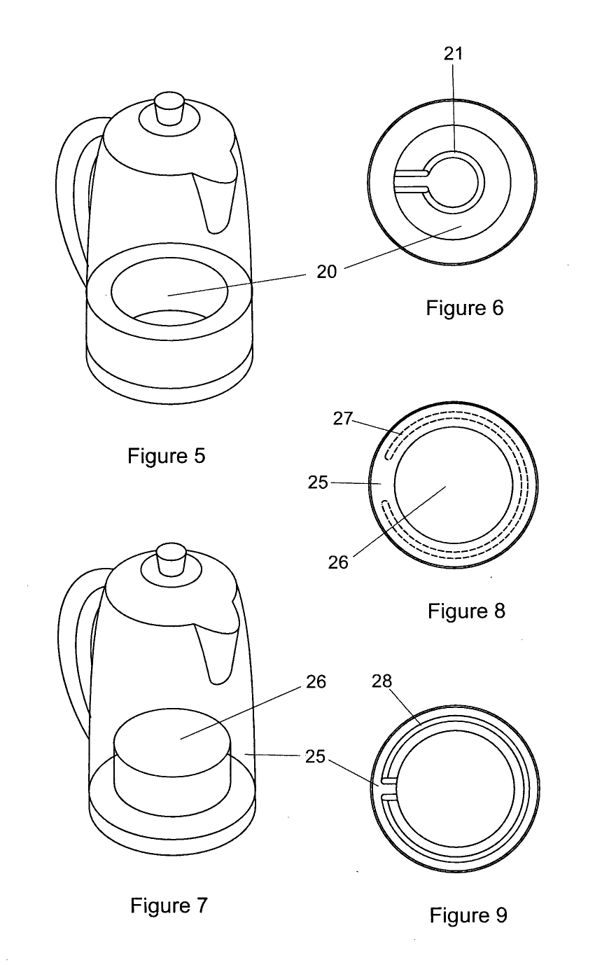

Turning now to the embodiment of the invention illustrated in FIGS. 5 and 6, a similar kettle is provided with a central circular lower region (20) of the water chamber that is formed as a central reduced diameter region of about 50% of the cross-sectional size of the lowermost outer periphery. An immersion heating element (21) is provided having a hot section at or towards the bottom of the lower region of the water chamber.

Turning now to the embodiment of the invention illustrated in FIGS. 7 and 8, the lower region (25) of the water chamber is, in this instance, formed to an annular shape with a central raised part (26) of the bottom of the water chamber forming an inner wall to the lower annular region of the water chamber. It is to be noted that this construction is clearly distinguishable from the arrangement described in EP1021117 in which a planar heating element 2 having a stepped formation 3 has an inner rim 4 and outer rim 5 such that the inner rim together with the walls of the vessel form a well 7 surrounding a central part of the element. The purpose of that well is to retain water for the purpose of absorbing heat and reducing the likelihood of heat generated by the element 2 damaging the vessel. The capacity of that well 7 is far short of the purpose achieved by the present invention and that well could not be used in exercising the present invention.

The heating element could be an external heating element (27), as indicated in FIG. 8, or it may be an immersion type of heating element (28), as illustrated in FIG. 9.

It will be understood that by providing a reduced cross-sectional area to the lower region of the water chamber, the vertical height of the water level in the lower region is greater than in the absence of such reduced cross-sectional area thereby providing for greater accuracy in filling the lower region of the water chamber of the kettle.

Numerous variations may be made to the embodiments of the invention described above without departing from the scope hereof. In particular, the internal shape of the water chamber could vary widely. Also there may be a smooth transition from the cross-sectional size of the lower region to that of the central region.

1. A kettle having a body with a lowermost outer periphery, a water chamber inside the body wherein the water chamber has a bottom, a lower region immediately above the bottom, a central region terminating in an upper maximum recommended operating volume, and an upper region constituting a head space, the water chamber having a maximum operating volume suitable for receiving at least 1 litre of water, a transparent wall section or window through which a volume of water within the water chamber can be visually observed between at least a minimum and a maximum recommended operating volume, and electrical heating means associated with said lower region of the water chamber for operatively heating water present in the water chamber, wherein the lower region of the water chamber has a capacity of not less than 200 millilitres, it has an average horizontal sectional area that is not more than 75% of the area enclosed by the lowermost outer periphery of the body, and a minimum volume of water of 400 millilitres or less is visible through the transparent wall section or window.

2. A kettle as claimed in claim 1 in which the minimum volume is not more than about 300 millilitres.

3. A kettle as claimed in claim 1 in which the maximum operating volume of the water chamber is at least 1.2 litres.

4. A kettle as claimed in claim 3 in which the maximum operating volume of the water chamber is from 1.4 to 2.0 litres.

5. A kettle as claimed in claim 1 in which the horizontal sectional area of the lower region of the water chamber has an average cross-sectional area that is less than 65% of the area enclosed by the lowermost outer periphery of the body.

6. A kettle as claimed in claim 5 in which the lower region of the water chamber has an average cross-sectional area that is not more than 50% of the area enclosed by the lowermost outer periphery of the body.

7. A kettle as claimed in claim 1 in which the capacity of the lower region of the water chamber is from 0.25 litres to 0.5 litres.

8. A kettle as claimed in claim 1 in which the lower region of the water chamber is formed as a diametrical channel extending between opposite sides of the lowermost outer periphery.

9. A kettle as claimed in claim 1 in which the lower region of the water chamber is formed as a central reduced diameter region of smaller cross-sectional size than the lowermost outer periphery of the body.

10. A kettle as claimed in claim 1 in which the lower region of the water chamber is of annular shape with a central raised part of the bottom of the water chamber forming an inner wall to the annular lower region of the water chamber.
